(19) United States
(12) Patent Application Publication
(10) Pub. No.: US 2017/0167586 A1
(43) Pub. Date: Jun. 15, 2017

(54) TORQUE CONVERTER LOCKUP CLUTCH INCLUDING PISTON SHIM

(71) Applicant: Schaeffler Technologies AG & Co. KG, Herzogenaurach (DE)

(72) Inventor: Matthew SMITH, Wooster, OH (US)

(21) Appl. No.: 14/966,713

(22) Filed: Dec. 11, 2015

(51) Int. Cl. F16H 45/02; F16D 13/40; F16D 13/58; F16D 25/0635

(52) U.S. Cl. CPC F16H 45/02; F16D 25/0635; F16D 13/40; F16D 13/58; F16D 2300/08; F16H 2045/0221; F16H 2045/0294

(57) ABSTRACT

A lockup clutch for a torque converter is provided. The lockup clutch includes a clutch plate and a piston assembly. The piston assembly includes a base section and a shim fixed to the base section. The shim is arranged for contacting the clutch plate to cause engagement of the lockup clutch. A method of forming a lockup clutch is also provided. The method includes fixing a shim to a base section to form a piston assembly; and arranging the piston assembly adjacent to a clutch plate such that the shim is arranged for contacting the clutch plate to cause engagement of the lockup clutch. A torque converter is also provided.

The present disclosure relates generally to torque converters and more specifically to lockup clutches of torque converters.

### BACKGROUND

U.S. Pub. No.: 2015/0300473 discloses a torque converter including a lockup clutch and a seal plate.

### SUMMARY OF THE INVENTION

A lockup clutch for a torque converter is provided. The lockup clutch includes a clutch plate and a piston assembly. The piston assembly includes a base section and a shim fixed to the base section. The shim is arranged for contacting the clutch plate to cause engagement of the lockup clutch.

A torque converter is also provided. The torque converter includes the lockup clutch and a damper assembly configured for transferring torque from the lockup clutch to a transmission input shaft when the lockup clutch is locked.

A method of forming a lockup clutch is also provided. The method includes fixing a shim to a base section to form a piston assembly; and arranging the piston assembly adjacent to a clutch plate such that the shim is arranged for contacting the clutch plate to cause engagement of the lockup clutch.

### BRIEF DESCRIPTION OF THE DRAWINGS

The present invention is described below by reference to the following drawings, in which:

FIG. 1 schematically shows a cross-sectional side view of a torque converter according to an embodiment of the present invention;

FIG. 2 schematically shows an enlarged view of a lockup clutch of the torque converter shown in FIG. 1;

FIG. 3 shows a plan view of a piston assembly of the lockup clutch shown in FIG. 2 in accordance with an embodiment of the present invention;

FIG. 4 schematically shows an example of staking a base section of the piston assembly shown in FIG. 2 to axially fix a shim to the base section in accordance with an embodiment of the invention;

FIG. 5 schematically shows another example of staking a base section of the piston assembly shown in FIG. 2 to axially fix a shim to the base section in accordance with an embodiment of the invention;

FIG. 6 shows a perspective view of a shim in accordance an embodiment of the present invention; and

FIG. 7 shows a method of forming the torque converter shown in FIG. 1 in accordance with an embodiment of the present invention.

### DETAILED DESCRIPTION

The disclosure allows a plurality of shims of different thicknesses to be attached to the same piston base section by for example staking, riveting, welding or bonding to selectively provide the desired clutch liftoff. Using shims with a base section also allows the base section to be riveted to a leaf spring, without the clutch contact surface of the piston assembly being interrupted by the rivets. A method of assembly is also provided including attaching the shim by staking and laser welding the seal plate to the cover hub.

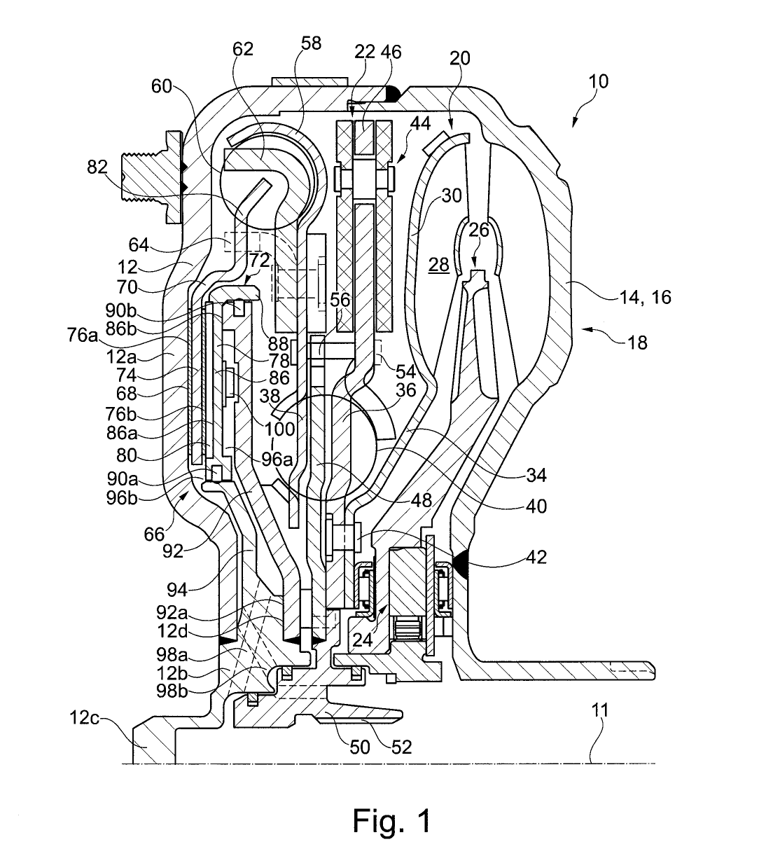

FIG. 1 shows a cross-sectional side view of a torque converter 10 in accordance with an embodiment of the present invention. Torque converter 10 is rotatable about a center axis 11 and includes a front cover 12 for connecting to a crankshaft of an internal combustion engine and a rear cover 14 forming a shell 16 of an impeller or pump 18. Front cover 12 includes cup shaped section 12a for connecting to a rear cover 14 and a hub section 12b including a pilot 12c for aligned with the crankshaft. Torque converter 10 also includes a turbine 20, which is positioned opposite impeller 18, and a damper assembly 22 fixed to turbine 20. Torque converter 10 further includes a stator 26 axially between impeller 18 and turbine 20 and a one-way clutch 24 supporting stator 26. Turbine 20 includes a plurality of blades 28 supported on a rounded portion 30 of turbine 20 at a rear-cover side of turbine 20. Turbine 20 further includes an inner radial extension 34 protruding radially inward from rounded portion 30. On a front-cover side of turbine 20, turbine 20 is connected to damper assembly 22.

Damper assembly 22 includes two cover plates 36, 38 supporting an inner set of springs 40 axially therebetween, with the turbine-side cover plate 36 being riveted to turbine 20 by a plurality of circumferentially spaced rivets 42. Damper assembly 22 further includes a centrifugal pendulum vibration absorber 44 at a radially outer end 46 of cover plate 36 and a drive flange 48 positioned axially between cover plates 36, 38. Drive flange 48 includes a drive hub 50 at an inner radial end thereof including splines 52 on an inner circumferential surface thereof configured for nonrotatably connecting to a transmission input shaft. Cover plates 36, 38 transfer torque from turbine 20 to drive flange 48 via springs 40. Drive flange 48 in turn drives the transmission input shaft via hub 50. Radially outside of springs 40, cover plates 36, 38 are riveted together by a plurality of circumferentially spaced rivets 54. Rivets 54 pass through cover plates 36, 38 into circumferential spaces formed between outer tabs 56 extending from a radial outer end of drive flange 48.

A radially outer end of cover plate 38 forms a spring retainer 58 retaining a set of radially outer springs 60. A further plate 62 of damper assembly 22 is riveted to a front cover side of cover plate 38 and extends into circumferential spaces between springs 60 to contact one circumferential end of each of springs 60. Plate 62 further includes projections 64 extending axially away from cover plate 38.

Torque converter 10 also includes a lockup clutch 66 formed by an inner radially extending surface 68 of front cover 12, a clutch plate 70 and a piston assembly 72. Clutch plate 70 includes a radially extending engagement section 74 including friction material 76a, 76b on both radially extending surfaces thereof. Piston assembly 72 includes a base section 78 and a shim 80 fixed to a radially extending surface of base section 78. A first friction material 76a is configured for contacting inner radially extending surface 68 and a second friction material 76b is configured for contacting shim 80. Clutch plate 70 further includes drive projections 82 on a radial outer end thereof extending through circumferential spaces between projections 64 and into the circumferential spaces between springs 60.

Base section 78 of piston assembly 72 includes a radially extending support section 86 for axially contacting and supporting shim 80 and an axially extending section 88 extending axially from an outer radial end of support section 86. Hub section 12b is configured as a support for base section 78, with hub section 12b being axially fixed and base section 78 being axially slidable with respect to hub section 12b. Base section 78 is provided with a radially inner seal 90a, held in a groove of base section 78, at an inner circumferential surface of support section 86 and a radially outer seal 90b, provided in a groove of a first radial extension 92 fixed to hub section 12b, at an inner circumferential surface of axially extending section 88. First radial extension 92 and a second radial extension 94, which is part of hub section 12b, form seal plates for slidably supporting base section 78. Frist radial extension 92 includes an axial mating surface 92a, which is a front cover-side radially extending surface thereof, held flush against a rear cover side radially extending surface 12d of hub section 12b. Seal 90a contacts an outer circumferential surface of a second seal plate 94 of hub section 12b and seal 90b contacts an outer circumferential surface of first seal plate 92.

First and second seal plates 92, 94 are axially and radially fixed in place in torque converter 10 and piston assembly 72 is axially movable along seals 90a, 90b with respect to first and second seal plates 92, 94. Seals 90a, 90b cause a front cover side of first seal plate 92, a rear cover side of second seal plate 94 and a rear cover side of piston assembly 72 to delimit a first pressure region 96a that is fed with fluid via a first pressure channel 98a formed in hub section 12b. A second pressure region 96b is formed by inner radially extending surface 68 of front cover 12, a front cover side of second seal plate 94, the front cover side of piston assembly 72 and clutch plate 70. Second pressure region 96b is fed with fluid via a second pressure channel 98b formed in hub section 12b. A leaf spring 100 is provided in first pressure region 96a elastically connecting piston assembly 72 to first seal plate 92. Leaf spring 100 extends axially between the rear cover side of base section 78 and the front cover side of first seal plate 92 and pulls piston assembly 72 away from clutch plate 70 and toward first seal plate 92.

When the pressure in first pressure region 96a is greater than the pressure in second pressure region 96b an amount to overcome the bias of leaf spring 100, lockup clutch 66 is locked by shim 80 of piston assembly 72 engaging friction material 76b of clutch plate 70 and sandwiching clutch plate 70 between surface 68 of front cover 12 and piston assembly 72 such that drive flange 48 is drivingly coupled to front cover 12 via damper assembly 22. When the pressure in second pressure region 96b and force generated by leaf spring 100 form a force that is greater than the force of the pressure in first pressure region 96a, lockup clutch 66 is unlocked such that drive flange 48 is driven via turbine 20 and the fluid flow between impeller 18 and turbine 20.

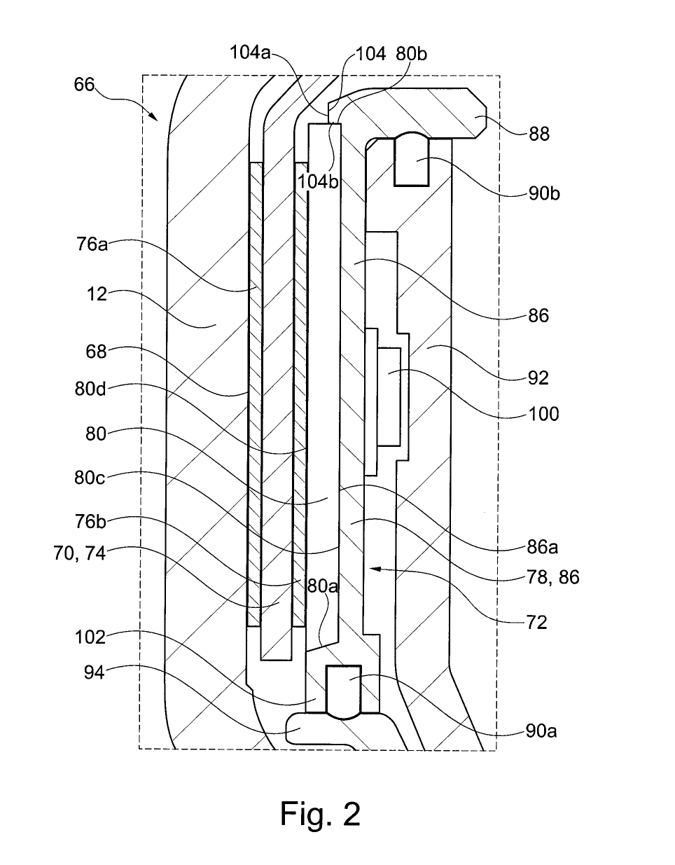

FIG. 2 shows an enlarged cross-sectional side view of piston assembly 72. As shown in FIG. 2, base section 78 of piston assembly 72 includes a radially inner shim support 102, which is axially wider than support section 86 and protrudes axially past support section 86 toward inner surface 68 of front cover 12, and a radially outer shim support 104, which is axially wider than support section 86 and protrudes axially past support section 86 toward inner surface 68 of front cover 12. In this embodiment, radially outer shim support 104 is radially aligned with axially extending section 88. Radially inner shim support 102 is formed radially inside of shim 80 and radially abuts an inner circumferential surface 80a of shim 80 and radially outer shim support 104 is radially outside of shim 80 and radially abuts an outer circumferential surface 80b of shim 80 so that supports 102, 104 radially align shim 80 with base section 78. Accordingly, shim 80 extends radially between supports 102, 104 along radially extending support section 86 with a rear radially extending surface 80c of shim 80 contacting a front radially extending surface 86a of radially extending support section 86. In other words, supports 102, 104 and radially extending support section 86 define an annular groove in base section 78 configured for receiving shim 80. Radially extending support section 86 further includes a rear radially extending surface 86b that may axially contact seal plate 92 in when lockup clutch 66 is unlocked. When lockup clutch 66 is locked, with piston assembly 72 pressing clutch plate 70 against radially extending surface 68, a front radially extending surface 80d of shim 80 contacts friction material 76b and shim 80 is sandwiched axially between friction material 76b and base section 78. In order allow sufficient axial contact between frictional material 76b and shim 80, front radially extending surface 80d of shim 80 is radially longer than friction material 76b.

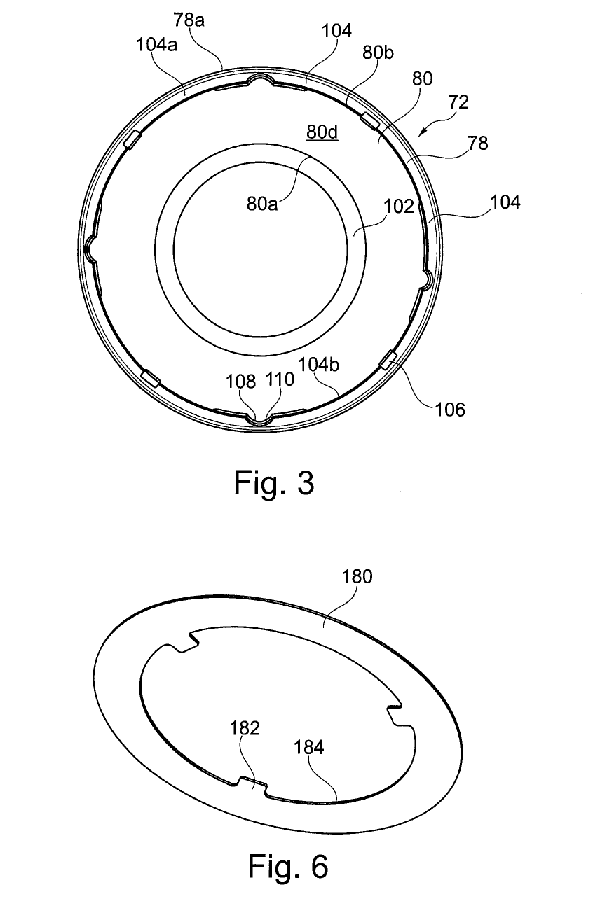

FIG. 3 shows a plan view of piston assembly 72. As shown in FIG. 3, base section 78 includes a plurality of connectors 106, in this example four connectors 106, fixing shim 80 axially in place on front radially extending surface 86a of radially extending section 86 of base section 78, with back radially extending surface 80c of shim contacting front radially extending surface 86a. Connectors 106 each extend radially inward past outer circumferential surface 80b of shim 80 such that connectors 106 each contact axial front surface 80d of shim 80 and/or extending radially into outer circumferential surface 80b. In the embodiment in FIG. 3, connectors 106 are formed by staking an outer circumferential surface 78a of base section 78 at radially outer shim support 104 and/or a front radially extending surface 104a of radially outer shim support 104. In other embodiments, shim 80 may be connected to base section 78 by for example riveting, welding or bonding. In the embodiment in FIG. 3, shim 80 is also provided with anti-rotation features for holding shim 80 circumferentially in place on base section 78 in the form of radially outwardly extending protrusions 108, in this example four protrusions 108, extending radially outward from outer circumferential surface 80b. Protrusions 108 extend into correspondingly shaped radially outwardly extending grooves 110 formed in an inner circumferential surface 104b of outer shim support 104. Shim 80 is held in place on base section 78 with inner circumferential surface 80a of shim 80 contacting an outer circumferential surface 102a of radially inner shim support 102 and outer circumferential surface 80b of shim 80 contacting inner circumferential surface 104b of radially outer shim support 104.

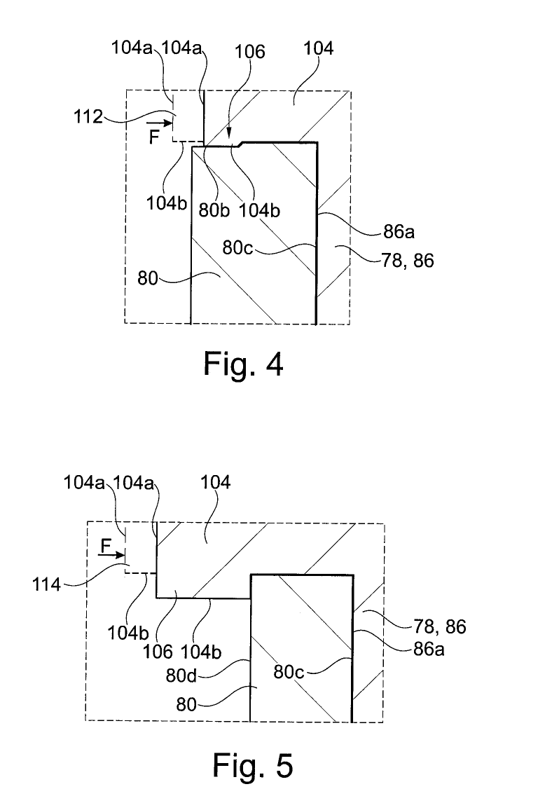

FIG. 4 schematically shows an example of staking base section 78 to axially fix shim 80 to base section 78. The dotted line outlines a portion 112 of base section 78 before the staking operation. Accordingly, FIG. 4 illustrates that a staking force F applied to front radially extending surface 104a moves radially extending surface 104a axially into base section 78 and generates connector 106, moving inner circumferential surface 104b at connector 106 radially inward into outer circumferential surface 80b of shim 80. During the staking, back radially extending surface 80c of shim 80 is held axially against front radially extending surface 86a of radially extending section 86 of base section 78.

FIG. 5 schematically shows another example of staking base section 78 to axially fix shim 80 to base section 78. The dotted line outlines a portion 114 of base section 78 before the staking operation. Accordingly, FIG. 5 illustrates that a staking force F applied to front radially extending surface 104a moves radially extending surface 104a axially into base section 78 and generates connector 106, moving inner circumferential surface 104b at connector 106 radially inward into such that inner circumferential surface 104b at connector extends radially inside of outer circumferential surface 80b of shim 80 and connector 106 contacts front radially extending surface 80d of shim 80. During the staking, back radially extending surface 80c of shim 80 is held axially against front radially extending surface 86a of radially extending section 86 of base section 78.

FIG. 6 shows a perspective view of a shim 180 in accordance with another embodiment of the present invention. Shim 180 varies from shim 80 in that, instead of anti-rotation features being in the form of radially outwardly extending protrusions 108, shim 180 includes anti-rotation features in the form of radially inwardly extending protrusions 182 extending radially outward from an outer circumferential surface 184 of shim 180. Radially inner shim support 102 of base section 78 may include correspondingly shaped radially inwardly extending grooves for receiving protrusions 108 and shim 180 may be fixed to base section 78 by for example staking, riveting, welding or bonding.

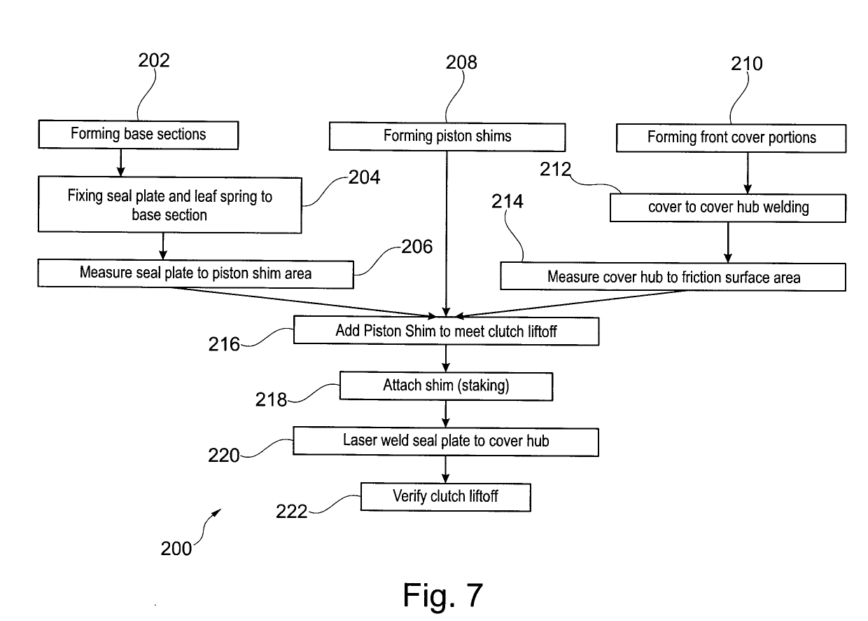

FIG. 7 shows a method 200 of forming lockup clutch 66 in accordance with an embodiment of the present invention. Method 200 includes a step 202 of forming a plurality of base sections 78. In a preferred embodiment, a plurality of identical base sections 78, of the same size and shaped, are formed by machining. After step 202, a seal plate 92 and a leaf spring 100 are fixed to each base section 78 in a step 204. More specifically, at first end of leaf spring 100 is riveted to base section 78 and a second end of leaf spring 100 is riveted to seal plate 92 such that leaf spring 100 connects base section 78 to seal plate 92. Next, in a step 206, an axial distance D1 between seal plate 92 to piston shim 80 is measured for a set including one seal plate 92 and one base section 78 joined together. More specifically, distance D1 is the axial distance from a front radially extending surface 86a of radially extending support section 86 of base section 78 to a hub mating surface 92a of seal plate 92 when rear side radially extending surface 86b of radially extending support section 86 contacts seal plate 92. Simultaneous to, before or after steps 202, 204, 206, a plurality of piston shims 80 are formed by machining during a step 208. In a preferred embodiment, shims 80 of varying thickness are formed. For example, a first set of the shims 80 may be of a first thickness, a second set of the shims 80 may be a second thickness greater than the first thickness, and a third set of the shims 80 may be a third thickness less than the first thickness, creating shims 80 of three different thicknesses. Simultaneous to, before or after steps 202, 204, 206, 208, a plurality of front cover sections 12a and a plurality of front cover sections 12b of the same size are formed during a step 210 by machining. After step 210, each front cover section 12a is joined to a corresponding front cover section 12b by welding in a step 212. Next, in a step 214, a cover hub to friction surface distance D2 is measured for a set including one front cover section 12a and one front cover section 12b joined together. More specifically, distance D2 is the axial distance between where the cover section 12a joined to a front radially extending surface of cover section 12b and radially extending surface 12d.

After steps 206, 208, 214, in a step 216, one of piston shims 80 is selected from the piston shims 80 of various thickness based on the measurements in steps 206 and 2014 is added to the base section 78 from step 206 based on the measurements in steps 206 and 214. Next, in a step 218, the piston shim 80 is fixed to the corresponding base section 78 by staking. As noted above, in other embodiments, shim 80 may be connected to base section 78 by for example riveting, welding or bonding. After step 218, and after clutch plate 74 is provided against front cover 12a, in a step 220 the seal plate 92 connected to the piston assembly 72 is fixed to front cover section 12b by laser welding. Then, in a step 222, a liftoff of the lockup clutch 66 formed is verified to ensure that the clutch liftoff is accurate. The dimensional difference between the distance D1 and distance D2 (and known thicknesses/low variation thicknesses of other features) allow a determination of a natural gap between piston assembly 72 and cover section 12a/clutch plate 74 when assembled. This natural gap is known as the clutch liftoff. To maintain the tight tolerance as required by the customer, some or all of the individual component thickness/step variations are measured and corrected by using shim 80. Small liftoff variations advantageously provide consistent piston stroke length.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A lockup clutch for a torque converter comprising:
a clutch plate; and
a piston assembly, the piston assembly including a base section and a shim fixed to the base section, the shim arranged for contacting the clutch plate to cause engagement of the lockup clutch.

2. The lockup clutch as recited in claim 1 wherein the clutch plate includes a friction material, the shim being arranged for contacting the friction material.

3. The lockup clutch as recited in claim 1 further comprising at least one seal plate slidably supporting the base section, the base section being axially slidable along the at least one seal plate in a first axial direction to cause engagement of the lockup clutch.

4. The lockup clutch as recited in claim 1 further comprising an inner radially extending surface of a torque converter front cover, the clutch plate arranged for being sandwiched axially between the inner radially extending surface and the shim during engagement of the lockup clutch.

5. The lockup clutch as recited in claim 1 further comprising a leaf spring connected to the base section biasing the piston assembly away from the clutch plate.

6. The lockup clutch as recited in claim 1 wherein the base section includes a radially extending section supporting the shim and an axially extending section extending axially from a first end of the radially extending section.

8. The lockup clutch as recited in claim 7 wherein the radially extending section includes connectors holding the shim axially against a front radially extending surface of the radially extending section.

9. The lockup clutch as recited in claim 8 wherein the connectors are staked portions of the base section.

10. A torque converter comprising:
the lockup clutch as recited in claim 1,
a damper assembly configured for transferring torque from the lockup clutch to a transmission input shaft when the lockup clutch is locked.

11. A method of forming a lockup clutch comprising:
fixing a shim to a base section to form a piston assembly; and
arranging the piston assembly adjacent to a clutch plate such that the shim is arranged for contacting the clutch plate to cause engagement of the lockup clutch.

12. The method as recited in claim 11 wherein the fixing the shim to the base section includes forming connectors on the base section axially fixing the shim to the base section.

13. The method as recited in claim 12 wherein the fixing the shim to the base section includes staking the base section to form the connectors.

14. The method as recited in claim 11 further comprising fixing the base section to a first seal plate via a leaf spring.

15. The method as recited in claim 14 further comprising fixing the first seal plate to a front cover.

16. The method as recited in claim 15 wherein the front cover includes a second seal plate, the first seal plate being fixed to the front cover such that the base section is axially slidable along the first and second seal plates.

17. The method as recited in claim 11 further comprising selecting the shim from a plurality of shim of differing thicknesses.
